(19) United States
(12) Patent Application Publication
(10) Pub. No.: US 2021/0390638 A1
(43) Pub. Date: Dec. 16, 2021

(54) COMPUTER-IMPLEMENTED METHODS FOR ADVANCED TENANT SCREENING

(71) Applicant: RENT BUTTER LLC, Chicago, IL (US)

(72) Inventors: Thomas RALEIGH, Chicago, IL (US); Christopher RANKIN, Chicago, IL (US)

(21) Appl. No.: 17/345,076

(22) Filed: Jun. 11, 2021

Related U.S. Application Data
(60) Provisional application No. 63/037,828, filed on Jun. 11, 2020.

(51) Int. Cl. G06Q 50/16; G06Q 30/06

(52) U.S. Cl. CPC G06Q 50/16; G06Q 30/0645

(57) ABSTRACT

Computer-implemented methods for advanced tenant screening are described herein. In one aspect, the computer-implemented method may include receiving identification information from a real estate rental applicant; performing a verification procedure for the real estate rental applicant based on the identification information; receiving, from at least one banking institution, account transaction information for the real estate rental applicant including at least a plurality of transactions; classifying the plurality of transactions according to a transaction type; calculating a set of payment coefficients from data contained within the classified transactions; and generating a payment probability value for the real estate rental applicant and from the set of coefficients.

### CROSS-REFERENCE TO RELATED APPLICATIONS

This application claims the benefit of U.S. Provisional Application No. 63/037,828 filed on Jun. 11, 2020, which is incorporated herein by reference in its entirety.

### BACKGROUND OF THE INVENTION

In the apartment real estate industry, it is well known that a landlord will screen the applicant before signing a lease with them. During the screening process, a landlord will require the applicant to fill out an application and may also require the applicant to provide references and proof of income. Upon receipt of that information, the landlord will generally run a full background check. The landlord will review credit scores provided by companies like

TransUnion or Experian. The landlord will also complete a criminal & eviction check. In addition, landlords will reach out to employers & prior landlords to verify certain information.

The question a landlord always has is: “If I sign a lease with them, will they pay their rent?” The credit score is the main factor the landlord will look at when assessing financial stability. Typically, a high credit score will indicate that the applicant will likely be a good paying tenant. But, when the credit score is low or non-existent, the landlord has a very challenging time determining whether they are going to be financially stable and a good paying tenant. Therefore, when the credit is low or non-existent, the landlord may simply deny them. Or, at best, the landlord will consider it a “coin flip” and possibly take a chance on them.

### SUMMARY

Computer implemented methods for advanced tenant screening are described herein. In one aspect, a computer-implemented can include receiving identification information from a real estate rental applicant; performing a verification procedure for the real estate rental applicant based on the identification information; receiving, from at least one banking institution, account transaction information for the real estate rental applicant including at least a plurality of transactions; classifying the plurality of transactions according to a transaction type; calculating a set of payment coefficients from data contained within the classified transactions; and generating a payment probability value for the real estate rental applicant and from the set of coefficients.

This aspect can include a variety of embodiments. In one embodiment, the set of coefficients can include at least a payment coefficient, and the method can further include: classifying a subset of the plurality of transactions as recurring debit payments; determining a set of payment due dates for recurring debit payments; and identifying a set of actual payment dates for the debit charges, where calculating the payment coefficient is based on the recurring debit payments, the set of payment due dates, and the actual payment dates.

In another embodiment, the set of coefficients can include a deposit coefficient, and the method can further include: classifying a subset of the plurality of transactions as deposit transactions; determining transaction dates for the deposit transactions; and determining a monetary amount for each of the deposit transactions, where calculating the deposit coefficient is based on the classified deposit transactions, the transaction dates, and the monetary amount for each deposit transaction.

In another embodiment, the method can further include classifying a subset of the plurality of transactions as expense transactions; classifying another subset of the plurality of transactions as deposit transactions; and calculating an expense-to-deposit coefficient from the expense transactions and the deposit transactions.

In another embodiment, the method can further include identifying a set of nonsufficient fund occurrences from the account transaction information, where generating the payment probability value is further based on the nonsufficient fund occurrences.

In another embodiment, the method can further include calculating expense values, savings values, and deposit values for the real estate rental applicant and over a predefined period of time. In some cases, the predefined period of time can include a week, a month, six months, a year, or a combination thereof.

In another embodiment, the method can further include calculating an on-time payment probability value for the real estate rental applicant based on the classified transactions, where the payment probability value is based at least in part on the on-time payment probability value.

In another embodiment, the payment probability value can include an ability-to-pay (ATP) value, where generating the ATP is further based on savings amounts, deposit amounts, and expense amounts for the real estate rental applicant.

In another embodiment, the payment probability value can include a willingness-to-pay (WTP) value, where generating the WTP is further based on savings amounts, deposit amounts, and expense amounts for the real estate rental applicant, debit payments by the real estate rental applicant, debit payment debit due dates for the real estate rental applicant, or a combination thereof.

In another embodiment, the method can further include generating a recommendation for credit approval for the real estate rental application based on the payment probability value. In some cases, the method can further include transmitting the recommendation for credit approval to a real estate leasing professional.

In another embodiment, the method can further include displaying the payment probability value and other financial statistics of the real estate rental applicant to a real estate leasing professional. In some cases, the other financial statistics can include the set of payment coefficients.

In another embodiment, the method can further include extracting the plurality of transactions from the account transaction information via a character recognition procedure. In some cases, the method can further include identifying a subset of the plurality of transactions contain same or similar characters; and determining a transaction type for the plurality of transaction from the same or similar characters.

In another embodiment, the method can further include comparing characters contained in the account transaction information with a list of target transactions module characters, where classifying the plurality of transactions is based on the comparing.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIGS. 1-6 depict workflow processes for advanced tenant screening according to embodiments of the present disclosure.

FIG. 7 depicts screenshots of prompts requesting tenant application financial institution information, according to an embodiment of the present disclosure.

FIGS. 8-10 depict analytics generated by a computer system for advanced tenant screening according to embodiments of the present disclosure.

FIG. 11 depicts a summary report for a tenant applicant according to an embodiment of the present disclosure.

### DEFINITIONS The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Computer-implemented methods for screening tenant applicants is described herein. The method can include the retrieval and analyzing of bank account transactions of the tenant applicant. A computer system can extract data from account information received from one or more banking institutions. The extracted data can then be classified into various transaction classifications, such as deposit, expenses, savings, and the like. The computer system can monitor the classified transactions over a period of time, which can indicate financial patterns of the tenant applicant. The computer system can also calculate different coefficients from the classified transactions, for example payment coefficients, deposit coefficients, and the like. The computer system can then generate a payment probability, and a tenant recommendation, for the tenant applicant based on the calculated coefficients. The methods described herein can provide landlords valuable insight into the applicant's financial behavior (account balances, insufficient funds fees, monthly expenses, categorical spending history, deposit verification, etc.). Thus, not only do the methods described herein utilize new data for landlords to access regarding an applicant's financial status, the methods described herein also generate new and useful analytics that landlords have never had access to previously. These analytics can assist landlords in making better and more informed lending decisions.

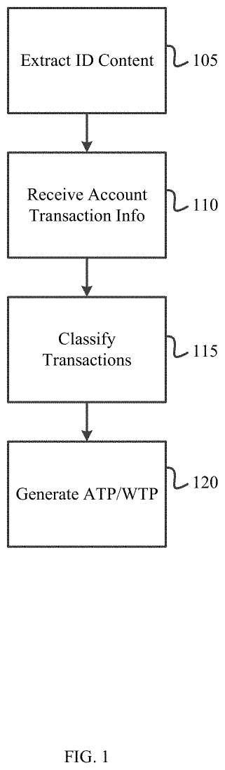

FIG. 1 depicts a workflow process according to an embodiment of the claimed invention. At Step 105, the identification content can be extracted for a tenant applicant. In some cases, a tenant may upload identification documents, such as a government issued I.D., to a computer system implementing the method described herein. The system can receive these identification documents and extract identification information for the tenant applicant, for example by performing a character recognition search or scraping the document. Identification information such as name—date of birth, place of residence, social security number, driver's license number, and the like can be extracted. The computer system can verify the extract identification content against the purported identity of the tenant applicant (e.g., the name and other identification information inputted by the applicant into the computer system or on a tenancy application).

At Step 110, account transaction information can be received by the computer system. The account transaction information can correspond to the tenant applicant, and can be received from a recognized banking institution or institutions. In some cases, tenant applicant may provide prior authorization for the computer system to receive the account transaction information from the banking institution. Further, the account transaction information can include a variety of information pertaining to bank accounts owned by the tenant applicant. For example, the account transaction information can include information pertaining to account ownership, type of transaction, monetary value of transaction, receiving party, transmitting party, account identification, date of transaction, and the like.

At Step 115, the bank transactions extracted from the account transaction information can be classified by the computer system. For example, a number of bank transactions can be extracted from the account transaction information, such as by character recognition techniques or by scraping the account transaction information. The classifications can include transaction type, such as deposits, expenses, savings, and the like. In some cases, the classifications can be more granular, such as by classifying the transactions based on recipient or transmitting party, by value amount, by date, and the like.

At Step 120, an ability-to-pay/willingness-to-pay (ATP/WTP) value can be generated for the tenant applicant. The ATP/WTP value can be based on various metrics obtained from the classified transactions, such as transaction type, dates, monetary amount, and the like. In some cases, the classified transactions can be further grouped, where metrics are then determined for the groups. For example, metrics for previous rent or mortgage payments can be determined from transactions grouped into a “rent or mortgage” group of transactions. These metrics can be used alone or in conjunction with other metrics, and can be used to determine an ATP/WTP value, which can then be displayed or transmitted to an authorized landlord (e.g., owner or agent for the property which the applicant is applying for tenancy).

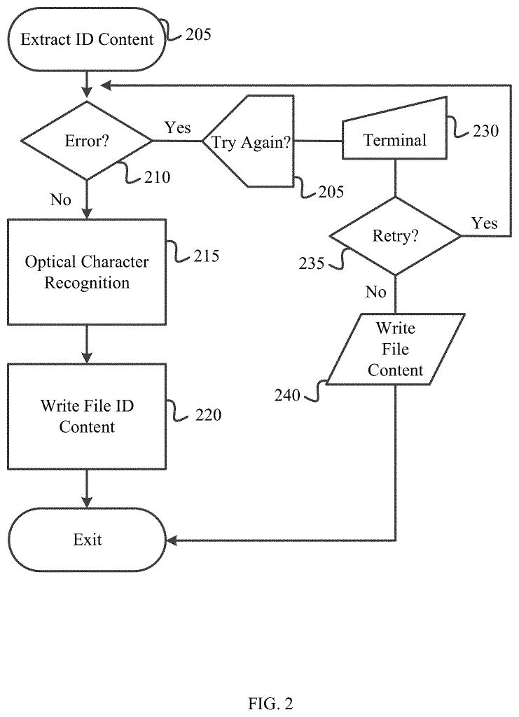

FIG. 2 is another workflow process according to an embodiment of the claimed invention. The workflow process depicted in FIG. 2 can be a more granular example of Step 105 of FIG. 1.

The extraction of identification content can be begin at Step 205. For example, identification documents for a tenant applicant can be previously uploaded or received by the computer system (e.g., by the tenant applicant). At Step 210, the computer system can identify whether any errors have occurred corresponding to the uploaded or inputted identification documents. For example, if the identification document was scanned incorrectly, or a corrupt file is uploaded, the system can identify this and determine an error has occurred.

If no error has been identified, the process can flow to Step 215. At Step 215, an optical character recognition procedure can be executed on the identification documents. The character recognition procedure can include identifying written characters (numerical, alphabetical, and the like) of the identification document. The optical character recognition procedure can then convert the identified characters into machine text. At Step 220, the system can then write the identification content to file (e.g. for storage and subsequent use).

If an error is identified at Step 210, the process can flow to Step 225, At 225, the system can generate a “try again?” message, which can be transmitted to a user terminal 230. The user terminal 230 can display the message to a user (e.g., the tenant applicant) (e.g., at Step 235), who can then respond in either the affirmative or the negative. If the terminal responds in the affirmative, the system can restart the identification extraction process (e.g., at Step 205), for example, by prompting the user to re-upload the identification documentation or upload new documentation. If the terminal responds in the negative, the system will write to file the identification contention (e.g., at Step 240) regardless of the identified errors.

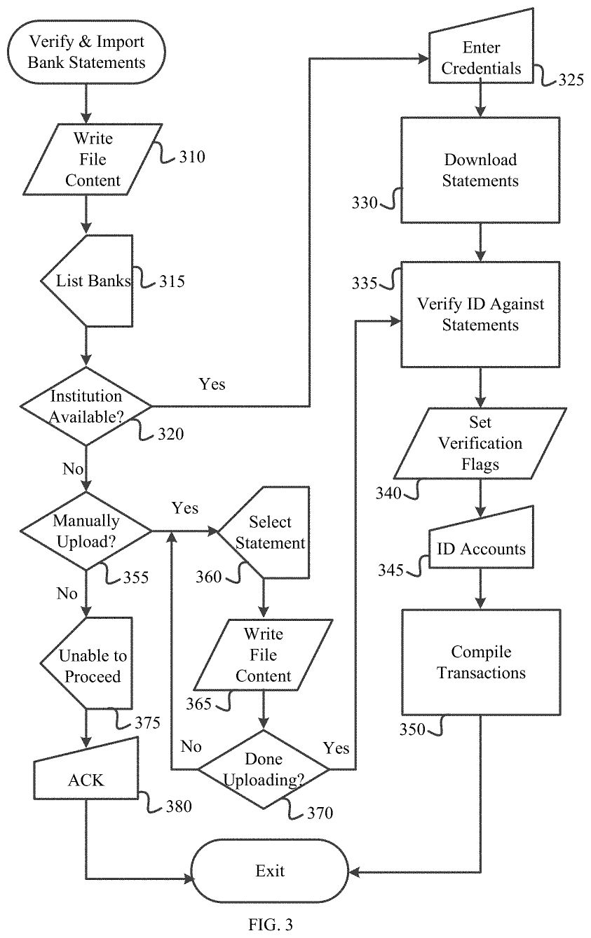

FIG. 3 depicts another workflow process according to an embodiment of the claimed invention. The workflow process depicted in FIG. 3 can be a more granular example of Step 115 as discussed with reference to FIG. 1.

The process can begin at Step 310. The computer system can read identification content. The computer system can read identification content previously written to file, for example at Step 220 in FIG. 2.

At Step 315, the computer system can display a list of available banking institutions (e.g., via a display to a user). The display may prompt a user (e.g., the tenant applicant) to select an institution from list. At Step 320, if an institution is selected by the user, then the process flows to Step 325.

At Step 325, the computer system can receive banking credentials corresponding to an account owned by the tenant applicant. For example, the computer system can receive information corresponding to username for an online account maintained by the banking institution, password for an online account, account number, answers to security questions, and the like.

At Step 330, the computer system can gain access to the financial account of the tenant applicant and download financial statements pertaining to the financial account. For example, the computer system can log in to a corresponding online or portal account for the tenant applicant that provides access to the financial accounts. In some other cases, the computer system can request access directly from the banking institution.

At Step 335, the computer system can verify the identity of the account owner. For example, the computer system may determine a name which the account is registered to. The computer system may compare the listed account name to the name provided by the tenant applicant (e.g., via the provided identification documents). Via the comparison, the computer can determine whether the registered account name matches the name of the tenant applicant.

At Step 340, the computer system can set verification flags for the financial accounts. For example, if the listed account name does not match the name provided in the identification documents, the computer system can flag the mismatch. A predefined mismatch threshold can be applied during the matching, for example, if more than one character is dissimilar between the identification documents and the account owner name. In some cases, the computer system can flag is more than one names is listed as the account owner (e.g., co-owners).

At Step 345, the computer system identify various accounts for the tenant applicant. For example, the computer system can identify checking deposit and expense accounts, savings accounts, and the like. The identification can be performed through a corresponding account number, an account description, and the like. At Step 350, the computer system can compile financial transactions from the identified accounts. For example, the computer system can identify a list of financial transactions either to or from an identified account, and aggregate the transactions from a predefined period of time (e.g., the past month, 6 months, a year, and the like).

If, at Step 320, the desired institution is not listed as an available institution, the computer system may request the user to manually upload financial transactions (e.g., at Step 355). If the user answers in the affirmative, the computer system at Step 360 can display a request to select a financial statement to upload. For example, the financial statement can be uploaded to the computer system by the user (e.g., from local storage, cloud storage, scanned documents, and the like). At 365, the computer system can write the file content containing the uploaded financial statement(s). At Step 370, the computer system can prompt the user to determine whether uploading of financial documents is complete. If answered in the negative, the process can flow back to Step 360 for additional manual uploading. Alternatively, if Step 370 is answered in the positive, the process can flow Step 355 to continue identity verification. In some cases, if there are no options for a bank account via auto or manual upload/download, applicant tenant can be prompted to upload pay stubs, tax returns, or other forms of income verification.

If Step 355 is answered in the negative (e.g., the user is unable to manually upload financial statements), the computer system can notify the user at Step 375 that the process is unable to proceed, thereby terminating the process. At Step 380, the user may be given the opportunity to acknowledge the termination, or inability to proceed in the process.

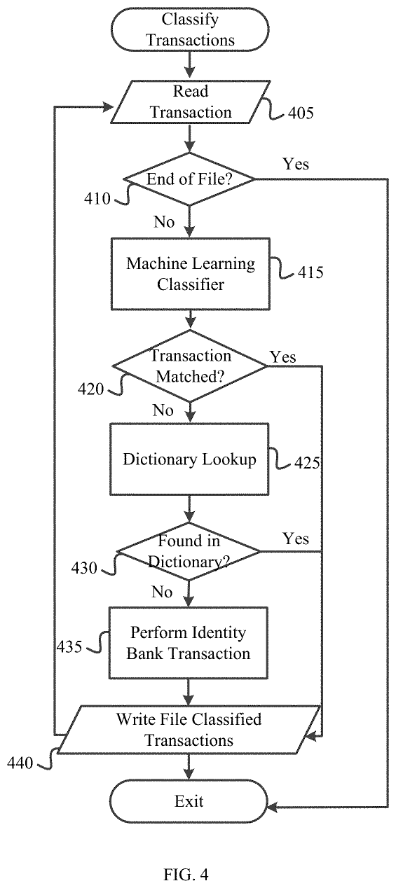

FIG. 4 depicts another workflow process according to an embodiment of the claimed invention. The workflow process depicted in FIG. 4 can be a more granular example of Step 115 as discussed with reference to FIG. 1.

At Step 405, the computer system can read a transaction corresponding to a tenant applicant. The transaction can originate from the compiled transactions discussed with reference to FIG. 3. The transaction can include transaction information such as sender, recipient, account owner name, date of transaction, value of transaction, general description of transaction, and the like. At Step 410, the computer system can determine whether the read transaction constitutes the end of the transaction file. If so, the process can flow to exit. If answered in the negative, the process can flow to Step 415.

At Step 415, the computer system can execute a machine learning classifier. The machine learning classifier can store or load a target transactions module, containing a list of identifiable transactions. Example machine learning models that can be implemented include, but are not limited to, linear regression, logistic regression, Random Forest, Decision Tree, K-Means, Naive Bayes, and the like.

At Step 420, the machine learning classifier can determine whether the transaction matches a transaction type stored in the target transactions module. For example, the machine learning classifier can identify characters across the transaction (e.g., words, numbering, and the like, in different areas or sections of the transaction, such as a “name” section, “description” section, and the like. If some of the characters match a stored transaction type, the machine learning classifier can determine the characters meet a predefined match confidence threshold. If so, the computer system can write to file the classified transaction (e.g., classifying the transaction) according to the matched transaction type at Step 440. If answered in the negative, the process can flow to Step 425.

At Step 425, the computer system can perform a dictionary lookup for the transaction. The computer system can identify the characters in the transaction, as discussed in Step 420 (e.g., a “name” section). The computer system can search (e.g., one or more search executions) a database of dictionary terms.

At Step 430, the computer system can determine whether a transaction type is found from the dictionary lookup. For example, the lookup procedure can return a number of results based on an order of likelihood to match. If none of the results meets a predefined match threshold (e.g., within 98% chance of a match), the computer system can determine that the transaction type is not found during the dictionary lookup. Alternatively, if a results meets the match threshold, the computer system can determine that the transaction type is found in the dictionary lookup, and proceed to Step 440 to write the classified transaction to file.

If the transaction type is not found during the dictionary lookup, the process can proceed to Step 435. At Step 435, the computer system can perform an bank transaction identity procedure. For example, if the computer system does not automatically identify and classify bank transactions, the applicant tenant can be prompted to manually select and identify certain transactions within a displayed bank statement. In some cases, this manual input can be used for training the machine learning classifier for future bank transaction identification and/or classification.

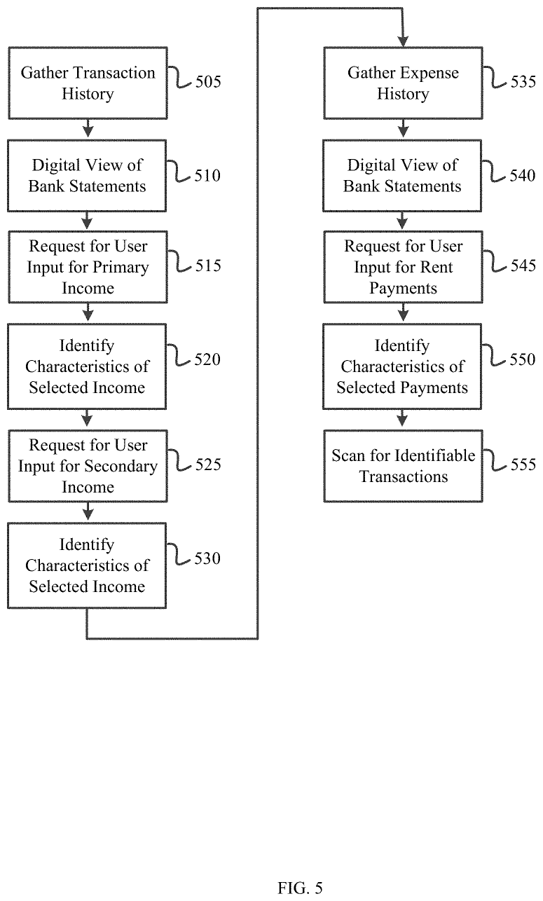

FIG. 5 depicts a workflow process for performing a transaction identify procedure according to an embodiment of the present disclosure. The workflow process of FIG. 5 can be a more granular example of Step 435 as discussed with reference to FIG. 4.

At Step 505, the computer system can download a transaction history compilation for the user. The compilation can include transaction histories from identified bank accounts, credit accounts, and the like.

At Step 510, the computer system can display a digital presentation of the transaction history compilation to the user. At Step 515, the computer system can request user input for selecting transactions corresponding to primary income sources. For example, the computer system can prompt the user to select one or more transactions pertaining to a paycheck from a primary job, and the like. At Step 520, the computer system can identify characteristics of any selected transactions for future searching. For example, the computer system can identify depositor identification, depositor address, transaction value amount, date of transaction, and the like.

At Step 525, the computer system can request user input for selecting transactions corresponding to secondary income sources. For example, the computer system can prompt the user to select one or more transactions pertaining to a paycheck from a secondary job, sporadic income payments, and the like. At Step 530, the computer system can identify characteristics of any selected transactions for future searching. For example, the computer system can identify depositor identification, depositor address, transaction value amount, date of transaction, and the like.

At Step 535, the computer system can download an expense transaction history compilation for the user. The compilation can include expense transaction histories from identified bank accounts, credit accounts, and the like.

At Step 540, the computer system can display a digital presentation of the expense transaction history compilation to the user. At Step 545, the computer system can request user input for selecting transactions corresponding to rent payments. At Step 550, the computer system can identify characteristics of any selected transactions for future searching. For example, the computer system can identify receiver identification, receiver address, transaction value amount, date of transaction, and the like.

At Step 555, the computer system can scan for additional transactions or rent payments based on identified characteristics of any selected transaction/rent payment. For example, the computer system can compare the identified receiver/depositor identification, receiver/depositor address, transaction value amount, date of transaction, and the like, to other transactions in the transaction history compilation/expense history compilation. If any of these characteristics matches to another transaction in a compilation, the computer system can flag the transaction as a possible additional income transaction or rent payment transaction.

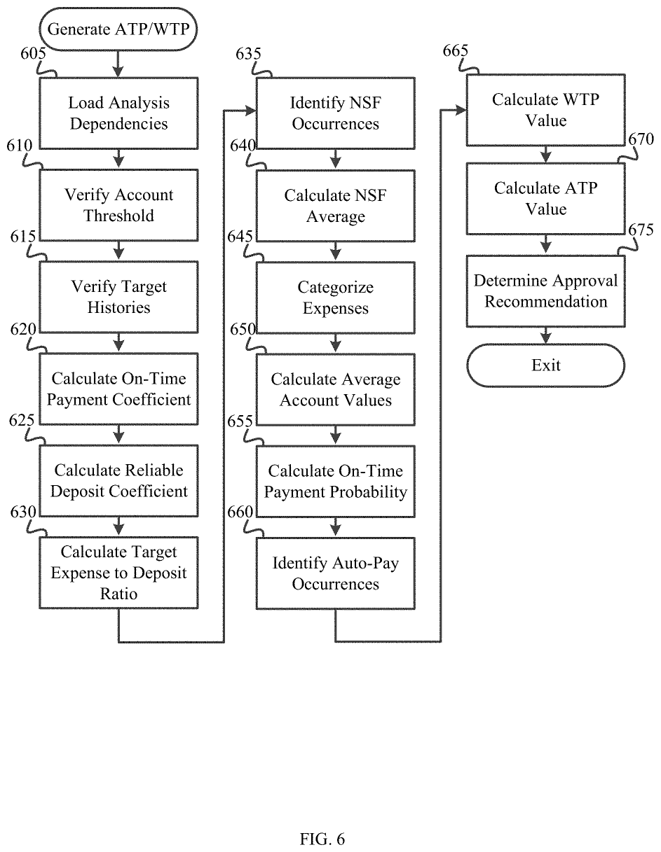

FIG. 6 depicts another workflow process according to an embodiment of the claimed invention. The workflow process depicted in FIG. 6 can be a more granular example of Step 120 as discussed with reference to FIG. 1.

At Step 605, the computer system can load analysis dependencies. The analysis dependencies can include the classified transactions, along with other metrics and characteristics of the transactions. For example, the computer system can load recipient, sender, transaction value, date of transaction, transaction type, number of similar occurrences, and the like.

At Step 610, the computer system can verify account thresholds. In some cases, the account thresholds can include a predefined time period (3 months, 6 months, 9 months, 12 months, and the like). At Step 615, the computer system can verify target transaction histories. For example, the computer system can monitor the dates of a compiled transaction. The computer system can identify the earliest and/or most recent transaction dates for the compiled transactions. Further, the computer system can identify a number of transactions which occurred within a predefined time period. For example, the computer system can identify the number of transactions that occurred within the previous month, 3 months, 6 months, and the like. The computer system determine whether the number of transactions occurring within the predefined time period meets or exceeds a target history threshold.

At Step 620, the computer system can calculate an on-time payment coefficient. The computer system can identify some transactions as expense transactions (e.g., in some cases during the classification process). The computer system can also determine expense payment due dates (if any) for the transactions, such as via user input, access online accounts corresponding to receiving entity which contains due date information, and the like. The computer system can compare the due dates to the actual payment dates of the transactions. Based on the comparisons, the computer system can determine for a transaction whether the transaction met the due date, or whether the transaction was a late payment. The computer system can aggregate these determinations, such that the computer system can identify a proportion of transactions which met the payment due date (e.g., the payment was on-time). From this aggregation, the computer system can calculate an on-time payment coefficient (e.g., 0.6 can represent 60% of expense transaction with due dates that are monitored were paid on-time within a predefined time period).

At Step 625, the computer system can calculate a reliable deposit coefficient. The reliable deposit coefficient can identify deposit transactions (e.g., in some cases through the classification process described above) that include a value greater than a predefined threshold or include a predefined description. For example, the tenant applicant can input a dollar amount for recurring or reliable deposits (e.g., from an employer), or can input a sender identity. The computer system can filter transactions based on the dollar amount or sender identity provided. The computer system can also identify the dates which these filtered transactions occur. The reliable deposit coefficient can be calculated from the number of filtered transaction occurring within a predefined timer period, such as a month, 3 months, 6 months, 12 months, and the like. For example, a reliable deposit coefficient of 0.8 can represent 8 out of 10 months having at least one filtered transaction occurring within the given month.

At Step 630, the computer system can calculate a target expense-to-deposit ratio. The computer system can identify expense transactions and deposit transactions (e.g., in some cases via the classification process described above). The computer system can also identify monetary amounts corresponding to each expense and deposit transaction. The computer system may aggregate the monetary amounts for expense transactions within a predefined time period (e.g., the last month, the last 3 months, the last 6 months, the last 12 months, and the like), and the computer system can also aggregate monetary values for deposit transactions within a predefined time period. The target expense-to-deposit ratio can be calculated form these aggregated monetary amounts.

At Step 635, the computer system can identify non-sufficient funds occurrences. For example, the computer system can identify total monetary value held in a financial account. If the total value is zero or below zero, the computer system can determine that a non-sufficient fund event occurred. In some cases, the computer system can identify overdrawn penalty fees, bounced check penalty fees, and the like, from the compiled transactions. The computer system can log these transactions as non-sufficient fund occurrences. Further, at Step 640, the computer system can calculate a non-sufficient fund average. For example, the computer system can determine the number of non-sufficient fund occurrences over a predefined period of time (e.g., a month, 3 months, a year, etc.).

At Step 645, the computer system can categorize expenses. The computer system can identify compiled transactions as expense transactions (e.g., in some cases during the classification process). The computer system can determine other characteristics of the transaction, such as fund recipient, a description of goods, and the like. From this information, the computer system can further categorize the expense transactions. For example, the computer system can categorize expenses into “housing,” “food,” “auto,” “social,” and the like.

At Step 650, the computer system can calculate average account values for the identified accounts. For example, the computer system can identify a monetary value held in each account at the end of a predefined time period (e.g., a month, 3 months, etc.). The computer system can average the identified monetary values held in an account over a predefined time span compared to the predefined time period (e.g., 3 months, 6 months, a year, two years, and the like). In some cases, the computer system can identify the monetary value based on a financial statement provided by the banking institution (e.g., a monthly statement or balance sheet). In some cases, the computer system can identify the monetary value based on aggregating the compiled transactions for an account over the predefined time period.

At Step 655, the computer system can identify auto-pay occurrences. An auto-pay occurrence can include automatic withdrawal or a credit expense as a transaction. In some cases, the auto-pay occurrence can be identified during the classification process (e.g., classified as “auto-pay”, and the like). In some cases, the computer system can identify an auto-pay occurrence from characteristics of the transaction, such as transaction description and the like. In some cases, the computer system can identify an auto-pay occurrence from a pattern of similar expenses, for example expense transactions identical in value, description, recipient, a recurring payment date, and the like.

At Step 660, the computer system can calculate an on-time payment probability. The on-time payment probability can be a value indicative of the tenant applicant's potential to pay expenses before or on their respective due dates. Further, the computer system can calculate the on-time payment probability from the classified transactions, the reliable deposit coefficient, and the like.

At Step 665, the computer system can calculate an ability-to-pay (ATP) value. The ATP value can be a value indicative of the tenant applicant's financial ability to pay rent, as opposed to the tenant applicant's desire to pay rent. The computer system can calculate the ATP from the classified transactions, on-time payment coefficient, reliable deposit coefficient, expense-to-deposit ratio, NSF occurrences, expenses, accounts values, on-time payment probability, auto-pay occurrences, and the like.

In some cases, the computer system can determine recent financial volatility events for the tenant applicant. “Recent financial volatility” can be a financial event or a series of financial events that a tenant applicant experiences within a time period (e.g., the last 12-24 months) that increases the likelihood of the tenant applicant defaulting on future rent payments. The computer system can identify and extract these recent volatile events by analyzing the tenant applicant's credit report as well as bank account transaction history.

Further, the computer system can identify “snow ball effect” financial events from the tenant applicant's transaction history. For example, the computer system can determine credit report volatility metrics, such as an increase in total balances in collections over a certain value threshold, an increase in number of pay day loan inquiries over a value threshold, a decrease in credit score values past a value threshold, an increase or decrease in available revolving credit, and the like.

In some cases, the computer system can determine bank account volatility metrics as part of the recent financial volatility determination. For example, the computer system can determine an increase in NSF counts above a value threshold for the tenant applicant. In some examples, the computer system can identify a decrease in savings or checking account balance above a percentage threshold. In some examples, the computer system can identify a decrease in monthly disposable income over a percentage threshold. In some cases, the computer system can further identify bill payment patterns, for example, whether the tenant applicant has a recent stable pattern of paying bills on time, or whether the tenant has an erratic pattern of paying bills on time.

At Step 670, the computer system can calculate a willingness-to-pay (WTP) value. The WTP value can be a value indicative of the tenant applicant's desire or choice to pay rent, as opposed to the tenant applicant's ability to pay rent. The computer system can calculate the WTP from the classified transactions, on-time payment coefficient, reliable deposit coefficient, expense-to-deposit ratio, NSF occurrences, expenses, accounts values, on-time payment probability, auto-pay occurrences, and the like.

At Step 675, the computer system can determine an approval recommendation for the tenant applicant. The recommendation can include either a “recommend” or “do not recommend” statement. The computer system can determine the recommendation based on the

WTP value, the ATP value, whether any flags were raised during the process, and the like. In some cases, the recommendation can also include reasoning for the resulting recommendation. For example, the major factors taken into account in determining the recommendation, any issues flagged by the computer system (e.g., identification mismatch, lack of account history, lack of number of accounts, and the like), etc. The computer system can transmit or display the recommendation to the corresponding landlord, property manager, or other authorized user.

### Practical Example

Described herein is an example of how the processes function from the perspective of the user. The example can implement the workflow processes described in more detail with respect to FIGS. 1-6. Some features performed by the computer system may not be privy to users (tenant applicant, landlord, etc.) of the system, and may instead be performed on the back end without being displayed.

A tenant applicant may login in to the Rent Butter home page (e.g., website, portal, etc.), or may sign up to gain access. Signing up may include inputting user information, such as identification, demographics, financial information, and the like. For example, the tenant applicant may also be requested to input current amount, rent payment method, gross and net income, method for receiving employment payment, and the like. Once accessed, the tenant application may be prompted with a request to upload identification information, such as a government issued I.D., to the system. The tenant applicant may upload identification information to the system.

The tenant applicant may further be prompted to input financial institution information for financial accounts to which the tenant applicant owns. The tenant applicant may be prompted with a list of financial institutions to select from. If the tenant applicant owns financial accounts managed by financial institutions outside of the displayed list, the tenant applicant can manually input institution information, such as name, headquarters address, federal employer identification number, and the like.

Once financial institutions are selected, the tenant applicant may be prompted to input financial account information into the computer system. For example, the tenant applicant can input account identification number, routing number, type of account, and the like. In some cases, the tenant applicant may input authentication credentials for accessing an online portal managed by the corresponding financial institution, which can subsequently provide access to account information of the tenant applicant. Once accessed, the tenant applicant may be further prompted to input additional information pertaining to the financial accounts. For example, the tenant applicant may be requested to select the financial account from which rent is currently paid, or select the account that receives income and other deposits.

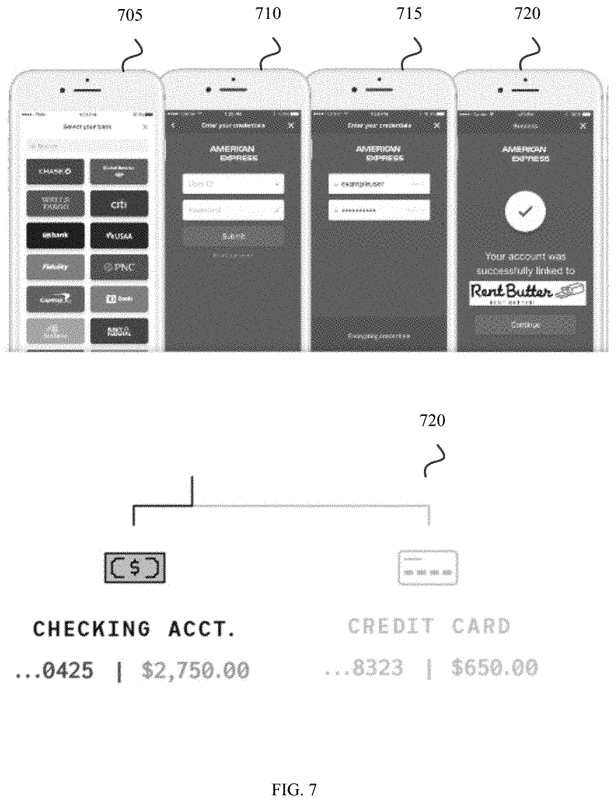

FIG. 7 depicts screenshots of a phone displays for a tenant applicant inputting financial institution information. Screenshot 705 depicts a list of financial institutions from which a tenant applicant may select from. Screenshot 710 depicts an information prompt requesting authentication credentials for accessing financial accounts of the selected financial institution. Screenshot 715 depicts filled-in authentication credentials for the corresponding financial institution. Screenshot 720 depicts a verification acknowledgement that the computer system has gained access to the tenant applicant's financial accounts managed by the financial institution. Screenshot 725 depicts a screenshot prompting the tenant applicant to select the financial account from which he/she currently pays rent from.

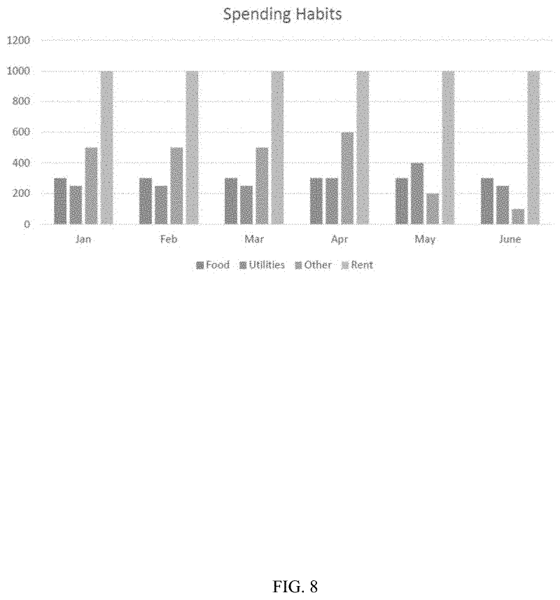

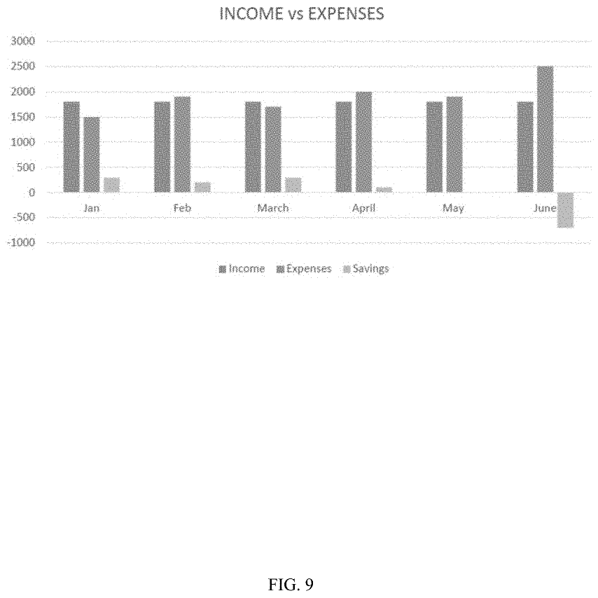

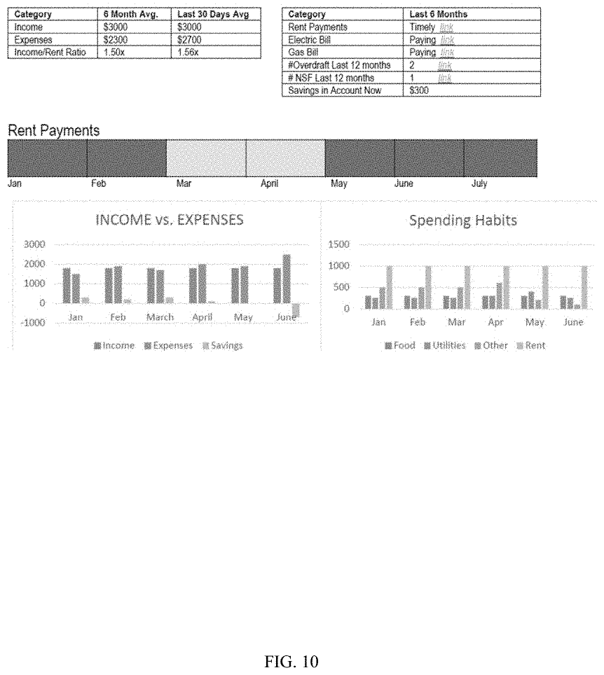

The computer system can implement the workflow features described in more detail with reference to FIGS. 1-6, which may result in the determining of various payment coefficients, probabilities, WTP and ATP values, and approval recommendations. The computer system can then display these results to an authorized landlord or property manager. The display can include analytics such as spending habits for the tenant applicant, income and expense patterns for the tenant applicant, rent timeliness, account balances, and the like. In some cases, the display can include analytics for past tenants or tenant applicants, which may provide the landlord a comparison for the current tenant applicant. FIGS. 8-10 depicts tenant applicant analytics that can be generated and displayed to a landlord or property manager. FIG. 8 depicts a graph of spending habits of a tenant applicant broken down into different categories. The spending habits can be broken down per month (or other time period) and into categories such as food, utilities, other, and rent, and the like. FIG. 9 depicts a graph of income and expenses for a tenant applicant. The graph can break down tenant applicant's financial transactions into income, expenses and savings on a monthly basis (or other time period). FIG. 10 depicts comprehensive analytics for a tenant applicant. For example, the analytics include categorized transactions values for the tenant applicant over the last month and a 6 month average. The analytics also include categorized expenses over the last 6 months, 12 months, and the like, such as rent payments, utility payments, and the like. The analytics also include a color bar indicating whether rent was paid on time for a given month. The analytics also include graphs corresponding tenant applicant income vs. expenses, and spending habits for the previous 6 months.

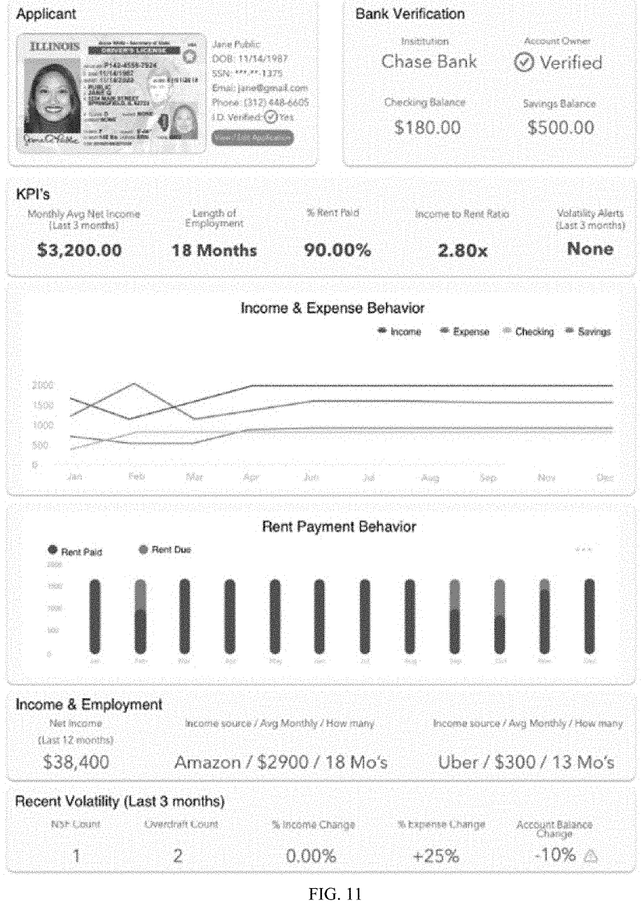

FIG. 11 also depicts a summary report for a tenant applicant according an embodiment of the present disclosure. The summary report can include the calculations and determinations discussed in in more detail with reference to FIGS. 1-6, and can be presented to a landlord or other authorized user. The summary report can include, for example, identification information of the tenant application, various analytics discussed in more detailed above, verification of the existence of financial accounts by third parties (e.g., the entity providing the account), employment information, rent payment analytics, and the like. Thus, the summary report can provide comprehensive, user-friendly presentation corresponding to a tenant applicant's financial statistics and behaviors.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A computer-implemented method, comprising:
receiving identification information from a real estate rental applicant;
performing a verification procedure for the real estate rental applicant based on the identification information;
receiving, from at least one banking institution, account transaction information for the real estate rental applicant comprising at least a plurality of transactions;
classifying the plurality of transactions according to a transaction type;
calculating a set of payment coefficients from data contained within the classified transactions; and
generating a payment probability value for the real estate rental applicant and from the set of coefficients.

2. The computer-implemented method of claim 1, wherein the set of coefficients comprises at least a payment coefficient, wherein the method further comprises:
classifying a subset of the plurality of transactions as recurring debit payments;
determining a set of payment due dates for recurring debit payments; and
identifying a set of actual payment dates for the debit charges, wherein calculating the payment coefficient is based on the recurring debit payments, the set of payment due dates, and the actual payment dates.

3. The computer-implemented method of claim 1, wherein the set of coefficients comprises a deposit coefficient, wherein the method further comprises:
classifying a subset of the plurality of transactions as deposit transactions;
determining transaction dates for the deposit transactions; and
determining a monetary amount for each of the deposit transactions, wherein calculating the deposit coefficient is based on the classified deposit transactions, the transaction dates, and the monetary amount for each deposit transaction.

4. The computer-implemented method of claim 1, further comprising:
classifying a subset of the plurality of transactions as expense transactions;
classifying another subset of the plurality of transactions as deposit transactions; and
calculating an expense-to-deposit coefficient from the expense transactions and the deposit transactions.

5. The computer-implemented method of claim 1, further comprising:
identifying a set of nonsufficient fund occurrences from the account transaction information, wherein generating the payment probability value is further based on the nonsufficient fund occurrences.

6. The computer-implemented method of claim 1, further comprising:
calculating expense values, savings values, and deposit values for the real estate rental applicant and over a predefined period of time.

7. The computer-implemented method of claim 6, wherein the predefined period of time comprises a week, a month, six months, a year, or a combination thereof.

8. The computer-implemented method of claim 1, further comprising:
calculating an on-time payment probability value for the real estate rental applicant based on the classified transactions, wherein the payment probability value is based at least in part on the on-time payment probability value.

9. The computer-implemented method of claim 1, wherein the payment probability value comprises an ability-to-pay (ATP) value, wherein generating the ATP is further based on savings amounts, deposit amounts, and expense amounts for the real estate rental applicant.

10. The computer-implemented method of claim 1, wherein the payment probability value comprises a willingness-to-pay (WTP) value, wherein generating the WTP is further based on savings amounts, deposit amounts, and expense amounts for the real estate rental applicant, debit payments by the real estate rental applicant, debit payment debit due dates for the real estate rental applicant, or a combination thereof.

11. The computer-implemented method of claim 1, further comprising:
generating a recommendation for credit approval for the real estate rental application based on the payment probability value.

12. The computer-implemented method of claim 11, further comprising:
transmitting the recommendation for credit approval to a real estate leasing professional.

13. The computer-implemented method of claim 1, further comprising:
displaying the payment probability value and other financial statistics of the real estate rental applicant to a real estate leasing professional.

14. The computer-implemented method of claim 13, wherein the other financial statistics comprise the set of payment coefficients.

15. The computer-implemented method of claim 1, further comprising:
extracting the plurality of transactions from the account transaction information via a character recognition procedure.

16. The computer-implemented method of claim 15, further comprising:
identifying a subset of the plurality of transactions contain same or similar characters; and determining a transaction type for the plurality of transaction from the same or similar characters.

17. The computer implemented method of claim 1, further comprising:
comparing characters contained in the account transaction information with a list of target transactions module characters, wherein classifying the plurality of transactions is based on the comparing.
